(19) United States
(12) Patent Application Publication
(10) Pub. No.: US 2019/0313682 A1
(43) Pub. Date: Oct. 17, 2019

(54) COMPOSITIONS AND METHODS FOR SUPPLEMENTING THE DIET

(71) Applicant: Metabolic Recovery Systems, LLC, Auburn, IN (US)

(72) Inventor: Ben Nagel, Auburn, IN (US)

(21) Appl. No.: 16/381,953

(22) Filed: Apr. 11, 2019

Related U.S. Application Data
(60) Provisional application No. 62/656,774, filed on Apr. 12, 2018.

(51) Int. Cl. A23L 33/12; A23L 33/105; A23L 29/30

(52) U.S. Cl. CPC A23L 33/12; A23L 33/105; A23L 29/30; A23V 2002/00; A23V 2250/044; A23V 2200/332; A23V 2250/1878; A23V 2250/626; A23V 2250/2108; A23V 2200/15

(57) ABSTRACT

Various aspects and embodiments disclosed herein relate generally to compositions that can be used to increase physical and mental energy, reduce the sensation of hunger. At least some of the composition disclosed herein can be used to obviate or moderate some of the discomfort which may be associated with initiating or maintaining reduced calorie and/or ketogenic diets.

### CROSS-REFERENCE TO RELATED APPLICATIONS

This application claims the benefit of U.S. Provisional Patent Application Ser. No. 62/656,774, filed Apr. 12, 2018, the disclosure of which is hereby expressly incorporated by reference in its entirety.

### FIELD OF THE INVENTION

Some aspects and embodiments disclosed herein relate generally to compositions that can be used to increase physical and mental energy, reduce the sensation of hunger. At least some of the compositions and methods disclosed herein can be used to obviate or moderate some of the discomfort which may be associated with initiating or maintaining reduced calorie and/or ketogenic diets.

### BACKGROUND AND SUMMARY

In a report published by the Center for Disease Control in 2016 this agency of the United States Federal Government reported that more than 70 percent of Americans are either overweight or obese. According, to the CDC Americans with a healthy Body to Mass Index (BMI) of 25 or less, is now a minority in America. The report cited by the CDC disclosed that about 37.9 percent of Americans age 20 and older had a BMI of 30 or higher, and about 32.8 percent of this same cohort overweight having a BMI between 25 and 29.9. The World Health Organization (WHO) has also documented a worldwide increase in the number of overweight and obese people.

The health risks of being obese or overweight are well documented and include an increased risk for developing hypertension, heart disease, Type II diabetes, and various forms of cancer. Most people recognize the value of achieving and maintaining a healthy body weight, this awareness coupled with society pressures to maintain a fit appearance has many individuals looking for ways to lose weight.

Various diets have been proffered to help people reduce body weight. Many mainstream nutritionists and physicians counsel balanced diets such as their outlined by the United States Department of Agriculture (USDA). The USDA guidelines call for a diet that derives less the 10 percent of its calories from added sugars and less than 10 percent of its calories from saturated fats. Other popular diets include low fat diets, sometimes defined as diets in which less than 20 percent of calories ingested each day are derived from all forms of fats. Still other popular diets include low carbohydrate diets such the Atkins Diet or the ketogenic diet. What all of these diets have in common is an understanding that for most people weight loss requires a reduction in the number of calories consumed over a sustained period of time.

The physiological rationale for low fat diets is the observation that an increase in blood sugar resulting from eating simple carbohydrates such as refined sugar elicits a spike in insulin production. High levels of insulin help to drive sugar into the cells of the body thereby reducing the level of sugar circulating in the blood stream leading to the sensation of hunger. Individuals on diets rich in simple carbohydrates, very often feel hungry which leads them to eat more calories. This spiral of eating induced hunger readily leads to weight gain.

In contrast to carbohydrate rich diets, diets which restrict the intake of carbohydrates include Very Low Carbohydrate Diets VLCD (Ketogenic), Low Carbohydrate Diets (LCD), Paleolithic Diets (PD), Calorie Restriction (CR), Intermittent Fasting (IF) and similar diets do not result in spikes of circulation insulin. Once they have adjusted to these types of low or essentially no carbohydrate diets many individuals report feeling hungry less often. Many of these same individuals also report rapid weight loss, increased levels of energy, and improved clarity of thought.

Individuals on relatively high fat low carbohydrate diets are thought to enter ketosis, a metabolic state characterized by elevated levels of ketone bodies in the blood. Generally, ketosis occurs when the body is converting fatty acids into ketones and the cells of the body are metabolizing ketones as their primary source of energy. Ketone bodies represent alternative energy substrates for both peripheral tissues and the central nervous system. During ketosis, fat stores in the body are utilized to create water soluble ketone bodies such as beta-hydroxybutyrate (βHB) and acetoacetate (also known as acetylacetonate), the main ketone bodies used for energy in the absence of high levels of circulating glucose. For this reason, ketosis is sometimes referred to as the body's “fat burning” mode. Long-term ketosis may result from ketogenic diets, calorie restriction, therapeutic fasting and/or supplementing the diet with ketogenic precursors.

Transitioning into ketosis may be aided by supplementing the diet with ketogenic foods or exogenous supplemental ketones. However, highly ketogenic fats like medium chain triglyceride oil (MCT oil) are generally not well tolerated by the gastrointestinal system. Additionally, oral administration of βHB and acetoacetate in their free acid form is expensive and ineffective for inducing or sustaining ketosis. Using the free acid form of βHB with sodium salts has been suggested; however, studies reported that this could elicit a potentially harmful sodium overload and mineral imbalance at therapeutic levels of ketosis. Moreover, testing in animal models of certain types of seizures have shown that such supplements are ineffective at preventing seizures (another benefit of some ketogenic diets). It is tempting to extrapolate from these studies that at least some ketogenic diet supplements are not inducing a truly ketone based metabolic state. Presumably, ketone salts with a balance of minerals are needed to prevent sodium overload, but an effective composition having such a balance of minerals is not commercially available.

Many individuals transitioning into ketosis, or starting ketogenic diets, report feeling lethargic and light-headed, this period of uncomfortable physiological and mental states is sometimes referred to as the “low carb flu.” These transitory symptoms may last as long as two to three weeks. If any carbohydrates over the restrictive amount are consumed, there is an immediate shift back to glucose utilization and the transition into ketosis must begin anew. Accordingly, the natural tendency to consume carbohydrates in or to treat the symptoms of the low carb flu may have the untended effect of undoing the dieters attempt to enter the metabolic state of ketosis.

A number of compositions for sustaining ketosis after the body enters a state of ketosis have been developed over the past decades; however, compositions that suppresses appetite and/or promotes ketosis without the need of changing diet are difficult to formulate in part due to the complications and variations in the amounts of food consumed by individuals. Therefore, there is a need for a new class of compositions that can aid in diets in general in ketogenic diets in particular.

A first embodiment includes a composition comprising at least one beta-hydroxybutyrate salt in an amount from about 0.1 g to about 10 g, or about 0.1 g to about 5 g, or about 0.1 g to about 3 g; and at least one agent comprising D-Ribose.

A second embodiment includes the composition according to claim 1, further comprising at least one medium chain fatty acid or ester thereof in an amount from about 0.1 g to about 20 g or about 0.1 g to about 10 g.

A third embodiment includes the composition according to any one of preceding embodiments, further comprising at least one compound comprising citric, tartaric, phosphoric and/or malic acid, caffeine, theacrine, L-theanine, L-tryptophan, cannabidiol, or a combination thereof.

A fourth embodiment includes the composition according to any one of the first to the third embodiments, wherein the at least one medium chain fatty acid or ester thereof comprises medium chain triglycerides, coconut oil, coconut milk powder, fractionated coconut oil, palm kernel oil, isolated hexanoic acid, isolated octanoic acid, isolated decanoic acid, ethoxylated triglyceride, enone triglyceride derivatives thereof, aldehyde triglyceride derivatives thereof, monoglyceride derivatives thereof, diglyceride derivatives thereof, triglyceride derivatives thereof, or an alkyl ester thereof.

A fifth embodiment includes compositions according to any one of the first to the fourth embodiments, wherein the at least one beta-hydroxybutyrate salt comprises sodium beta-hydroxybutyrate, arginine beta-hydroxybutyrate, potassium beta-hydroxybutyrate, calcium beta-hydroxybutyrate, magnesium beta-hydroxybutyrate, lithium beta-hydroxybutyrate, lysine beta-hydroxybutyrate, histidine beta-hydroxybutyrate, omithine beta-hydroxybutyrate, creatine beta-hydroxybutyrate, agmatine beta-hydroxybutyrate, or citrulline beta-hydroxybutyrate.

A sixth embodiment includes the composition according to any one of the first to the fifth embodiments, wherein the at least one medium chain fatty acid or ester thereof is present in an amount from about 1 g to about 5 g, from about 1 g to about 4 g, from about 1 g to about 3 g, from about 1 g to about 2 g, from about 2 g to about 3 g, from about 1.5 g to about 3.5 g, from about 2 g to about 4 g, from about 2 g to about 5 g, from about 3 g to about 4 g, from about 2.5 g to about 3.5 g, from about 3.5 g to about 4.5 g, or from about 1.5 g to about 4.5 g.

A seventh embodiment includes the composition according to any one of the first to the sixth embodiments, wherein the at least one beta-hydroxybutyrate salt is presented in an amount from about 0.1 g to about 5 g, from about 0.1 g to about 4 g, from about 0.1 g to about 3 g, from about 1 g to about 5 g, from about 1 g to about 4 g, from about 1 g to about 3 g, from about 1 g to about 2 g, from about 2 g to about 3 g, from about 1.5 g to about 3.5 g, from about 2 g to about 4 g, from about 2 g to about 5 g, from about 3 g to about 4 g, from about 2.5 g to about 3.5 g, from about 3.5 g to about 4.5 g, or from about 1.5 g to about 4.5 g.

An eighth embodiment includes the composition according to any one of the first to the seventh embodiments, wherein the composition comprises caffeine, and wherein the caffeine is presented in an amount from about 1 mg to about 300 mg, from about 1 mg to about 250 mg, from about 1 mg to about 200 mg, from about 1 mg to about 100 mg, from about 1 mg to about 50 mg, 10 mg to about 300 mg, from about 10 mg to about 250 mg, from about 10 mg to about 200 mg, from about 10 mg to about 100 mg, from about 10 mg to about 50 mg, from about 50 mg to about 300 mg, from about 50 mg to about 250 mg, from about 50 mg to about 200 mg, from about 50 mg to about 100 mg, from about 50 mg to about 80 mg, from about 60 mg to about 80 mg, about 50 mg, about 60 mg, about 70 mg, about 75 mg, and/or about 80 mg.

A ninth embodiment includes the composition according to any one of the first to the eighth embodiments, wherein the composition comprises theacrine, and wherein the theacrine is presented in an amount from about 1 mg to about 250 mg, from about 1 mg to about 200 mg, from about 1 mg to about 150 mg, from about 1 mg to about 100 mg, from about 1 mg to about 50 mg, 10 mg to about 300 mg, from about 10 mg to about 250 mg, from about 10 mg to about 200 mg, from about 10 mg to about 100 mg, from about 10 mg to about 50 mg, from about 50 mg to about 300 mg, from about 50 mg to about 250 mg, from about 50 mg to about 200 mg, from about 50 mg to about 100 mg, from about 50 mg to about 80 mg, from about 60 mg to about 80 mg, from about 20 mg to about 80 mg, from about 30 mg to about 70 mg, from about 40 mg to about 60 mg, about 30 mg, about 40 mg, about 45 mg, about 50 mg, and/or about 60 mg.

A tenth embodiment includes the composition according to any one of the first to the ninth embodiments, wherein the composition comprises: from about 1 g to about 3 g sodium beta-hydroxybutyrate; from about 1 g to about 3 g potassium beta-hydroxybutyrate; from about 0.5 g to about 2 g magnesium beta-hydroxybutyrate; from about 100 mg to about 200 mg caffeine; from about 50 mg to about 200 mg citric, tartaric, phosphoric and/or malic acid; and/or from about 0.5 g to about 5 g D-Ribose; or wherein the composition comprises: from about 1 g to about 3 g sodium beta-hydroxybutyrate; from about 1 g to about 3 g potassium beta-hydroxybutyrate; from about 0.5 g to about 2 g magnesium beta-hydroxybutyrate; from about 100 mg to about 200 mg caffeine; from about 50 mg to about 200 mg citric, tartaric, phosphoric and/or malic acid; from about 0.5 g to about 2 g tartaric acid, and/or from about 0.5 g to about 5 g D-Ribose; or wherein the composition comprises: from about 2 g sodium beta-hydroxybutyrate; from about 2 g potassium beta-hydroxybutyrate; from about 1 g magnesium beta-hydroxybutyrate; from about 100 mg to about 150 mg caffeine; from about 100 mg to about 150 mg citric, tartaric, phosphoric and/or malic acid; about 1 g tartaric acid, and/or from about 1 g D-Ribose. Consistent with these embodiments, the composition further comprises at least one sweetener and/or at least one flavoring agent (flavorant).

An eleventh embodiment includes the composition according to any one of the first to the tenth embodiments, wherein the composition comprises from about 2 g to about 4 g medium chain triglycerides having greater than 90% octanoic acid and less than 10% decanoic acid; from about 1 g to about 3 g calcium beta-hydroxybutyrate; from about 1 g to about 3 g sodium beta-hydroxybutyrate; from about 1 g to about 3 g magnesium beta-hydroxybutyrate; from about 50 mg to about 90 mg caffeine; from about 30 mg to about 70 mg theacrine; from about 1 mg to about 500 mg citric, tartaric, phosphoric and/or malic acid; and/or from about 0.5 g to about 5 g D-Ribose. Consistent with these embodiments, the composition further comprises at least one sweetener and/or at least one flavoring agent (flavorant).

A twelfth embodiment includes a use of a composition according to any one of the first to the eleventh embodiments for reducing food consumption and/or body weight in a subject who is on a diet naturally rich in MCT.

A thirteenth embodiment includes a dietary supplement, comprising from about 1 mg to about 300 mg caffeine; from about 1 mg to about 250 mg theacrine; and/or from about 0.5 g to about 5 g D-Ribose; wherein the dietary supplement is used in conjunction with a composition comprising at least one medium chain fatty acid and at least one beta-hydroxybutyrate salt.

A fourteenth embodiment includes the dietary supplement according to the thirteenth embodiment, wherein the caffeine is presented in an amount from about 1 mg to about 300 mg, from about 1 mg to about 250 mg, from about 1 mg to about 200 mg, from about 1 mg to about 100 mg, from about 1 mg to about 50 mg, 10 mg to about 300 mg, from about 10 mg to about 250 mg, from about 10 mg to about 200 mg, from about 10 mg to about 100 mg, from about 10 mg to about 50 mg, from about 50 mg to about 300 mg, from about 50 mg to about 250 mg, from about 50 mg to about 200 mg, from about 50 mg to about 100 mg, from about 50 mg to about 80 mg, from about 60 mg to about 80 mg, about 50 mg, about 60 mg, about 70 mg, about 75 mg, and/or about 80 mg.

A fifteenth embodiment includes the dietary supplement according to any one of the thirteenth to the fourteenth embodiments, wherein the theacrine is presented in an amount from about 1 mg to about 250 mg, from about 1 mg to about 200 mg, from about 1 mg to about 150 mg, from about 1 mg to about 100 mg, from about 1 mg to about 50 mg, 10 mg to about 300 mg, from about 10 mg to about 250 mg, from about 10 mg to about 200 mg, from about 10 mg to about 100 mg, from about 10 mg to about 50 mg, from about 50 mg to about 300 mg, from about 50 mg to about 250 mg, from about 50 mg to about 200 mg, from about 50 mg to about 100 mg, from about 50 mg to about 80 mg, from about 60 mg to about 80 mg, from about 20 mg to about 80 mg, from about 30 mg to about 70 mg, from about 40 mg to about 60 mg, about 30 mg, about 40 mg, about 45 mg, about 50 mg, and/or about 60 mg.

A sixteenth embodiment includes the composition and/or the dietary supplement according to any one of the first to the fifteenth embodiments, further comprising at least one agent comprising one or more sweeteners, one or more flavorants, one or more preservatives, and/or any combination thereof.

A seventeenth embodiment includes the composition and/or the dietary supplement according to any one of the first to the sixteenth embodiments, wherein the composition and/or the dietary supplement is formulated into a liquid, and/or wherein the composition and/or the dietary supplement is formulated into a liquid in a total of about 2 oz, and/or wherein the composition and/or the dietary supplement reduces food consumption in a subject.

An eighteenth embodiment includes a method of reducing food consumption in a subject, comprising: administering to a subject a therapeutically effective amount of the composition according to any one of the first to the eleventh embodiments.

A nineteenth embodiment includes the method according to the eighteenth embodiment, wherein the therapeutically effective amount of the composition according to any one of the first to the eleventh embodiments is administered to the subject once, twice, or three times per day.

A twentieth embodiment includes the method according to any one of the eighteenth to the nineteenth embodiments, wherein the subject is not on a ketogenic diet and/or wherein the subject is on a diet naturally rich in MCT.

A twenty first embodiment includes a dietary supplement for use in a subject who is on a diet naturally rich in MCT, comprising at least one beta-hydroxybutyrate salt and at least one agent comprising from about 0.5 g to about 5 g D-Ribose.

A twenty second embodiment includes the dietary supplement according to the twenty first embodiment, further comprising at least one compound comprising citric, tartaric, phosphoric and/or malic acid, caffeine, theacrine, L-theanine, L-tryptophan, cannabidiol, or any combination thereof.

A twenty third embodiment includes the dietary supplement according to any one of the twenty first and the twenty second embodiments, wherein the at least one beta-hydroxybutyrate salt comprises sodium beta-hydroxybutyrate, arginine beta-hydroxybutyrate, potassium beta-hydroxybutyrate, calcium beta-hydroxybutyrate, magnesium beta-hydroxybutyrate, lithium beta-hydroxybutyrate, lysine beta-hydroxybutyrate, histidine beta-hydroxybutyrate, omithine beta-hydroxybutyrate, creatine beta-hydroxybutyrate, agmatine beta-hydroxybutyrate, or citrulline beta-hydroxybutyrate.

A twenty fourth embodiment includes the dietary supplement according to any one of the twenty first to the twenty third embodiments, wherein the at least one beta-hydroxybutyrate salt is presented in an amount from about 0.1 g to about 5 g, from about 0.1 g to about 4 g, from about 0.1 g to about 3 g, from about 1 g to about 5 g, from about 1 g to about 4 g, from about 1 g to about 3 g, from about 1 g to about 2 g, from about 2 g to about 3 g, from about 1.5 g to about 3.5 g, from about 2 g to about 4 g, from about 2 g to about 5 g, from about 3 g to about 4 g, from about 2.5 g to about 3.5 g, from about 3.5 g to about 4.5 g, or from about 1.5 g to about 4.5 g.

A twenty fifth embodiment includes the dietary supplement according to any one of the twenty first to the twenty fourth embodiments, wherein the supplement comprises caffeine, and wherein the caffeine is presented in an amount from about 1 mg to about 300 mg, from about 1 mg to about 250 mg, from about 1 mg to about 200 mg, from about 1 mg to about 100 mg, from about 1 mg to about 50 mg, 10 mg to about 300 mg, from about 10 mg to about 250 mg, from about 10 mg to about 200 mg, from about 10 mg to about 100 mg, from about 10 mg to about 50 mg, from about 50 mg to about 300 mg, from about 50 mg to about 250 mg, from about 50 mg to about 200 mg, from about 50 mg to about 100 mg, from about 50 mg to about 80 mg, from about 60 mg to about 80 mg, about 50 mg, about 60 mg, about 70 mg, about 75 mg, and/or about 80 mg.

A twenty sixth embodiment includes the dietary supplement according to any one of the twenty first to the twenty fifth embodiments, wherein the supplement comprises: from about 1 g to about 3 g sodium beta-hydroxybutyrate; from about 1 g to about 3 g potassium beta-hydroxybutyrate; from about 0.5 g to about 2 g magnesium beta-hydroxybutyrate; from about 100 mg to about 200 mg caffeine; from about 50 mg to about 200 mg citric, tartaric, phosphoric and/or malic acid; and/or from about 0.5 g to about 5 g D-Ribose; or wherein the supplement comprises: from about 1 g to about 3 g sodium beta-hydroxybutyrate; from about 1 g to about 3 g potassium beta-hydroxybutyrate; from about 0.5 g to about 2 g magnesium beta-hydroxybutyrate; from about 100 mg to about 200 mg caffeine; from about 50 mg to about 200 mg citric, tartaric, phosphoric and/or malic acid; from about 0.5 g to about 2 g tartaric acid, and/or from about 0.5 g to about 5 g D-Ribose; or wherein the supplement comprises: from about 2 g sodium beta-hydroxybutyrate; from about 2 g potassium beta-hydroxybutyrate; from about 1 g magnesium beta-hydroxybutyrate; from about 100 mg to about 150 mg caffeine; from about 100 mg to about 150 mg citric, tartaric, phosphoric and/or malic acid; about 1 g tartaric acid, and/or from about 1 g D-Ribose. Consistent with these embodiments, the composition further comprises at least one sweetener and/or at least one flavoring agent (flavorant).

A twenty seventh embodiment includes the dietary supplement according to any one of the twenty first to the twenty sixth embodiments, wherein the dietary supplement is formulated into a liquid, wherein the dietary supplement is formulated into a liquid in a total of about 2 oz, and/or wherein the dietary supplement reduces food consumption in a subject.

A twenty eighth embodiment includes the composition and/or the dietary supplement according to any one of the preceding embodiments, wherein the composition and/or the dietary supplement comprises any one of the compositions recited in Tables 1-6 or any combination thereof.

### BRIEF DESCRIPTION OF THE FIGURES

FIG. 1. Graph illustrating the effect of Composition A administered to human subjects on indicated variables at indicated days after the treatment.

FIG. 2. Graph illustrating the effect of a Placebo administered to human subjects on indicated variables at indicated days after the treatment.

### DETAILED DESCRIPTION

For the purposes of promoting an understanding of the principles of the novel technology, reference will now be made to the preferred embodiments thereof, and specific language will be used to describe the same. It will nevertheless be understood that no limitation of the scope of the novel technology is thereby intended, such alterations, modifications, and further applications of the principles of the novel technology being contemplated as would normally occur to one skilled in the art to which the novel technology relates are within the scope of this disclosure and the claims.

As used herein, unless explicitly stated otherwise or clearly implied otherwise the term ‘about’ refers to a range of values plus or minus 10 percent (“±10%”), e.g. about 1.0 encompasses values from 0.9 to 1.1.

The term, “treating” as used herein unless stated or implied otherwise, includes administering to a human or an animal patient at least one dose of a compound, treating includes preventing or lessening the likelihood and/or severity of at least one disease as well as limiting the length of an illness or the severity of an illness, treating may or may not result in a cure of the disease.

As used herein, unless explicitly stated otherwise or clearly implied otherwise the terms ‘therapeutically effective dose,’ ‘therapeutically effective amounts,’ and the like, refer to a portion of a compound that has a net positive effect on health and well-being of a human or other animal. Therapeutic effects may include an improvement in longevity, quality of life and the like these effects also may also include a reduced susceptibility to developing disease or deteriorating health or well-being. The effects may be realized after a single dose and/or treatment or they may be cumulative realized after a series of doses and/or treatments. A “therapeutically effective amount” in general means the amount that, when administered to a subject or animal for treating a disease, is sufficient to affect the desired degree of treatment for the disease.

The term, “subject” as used herein unless stated or implied otherwise, includes, but is not limited to, an animal, a primate, and a human.

As used herein “beta-hydroxybutyrate,” also known as βHB or BHB, is a carboxylic acid having the general formula CH₃CH₂OHCH₂COOH. Mineral salts of RIB include, but are not limited to, potassium βHB, sodium βHB, calcium βHB, magnesium βHB, lithium βHB and any other feasible non-toxic mineral salts of βHB. Organic salts of βHB include, but are not limited to, salts of organic bases such as arginine βHB, lysine βHB, histidine βHB, ornithine βHB, creatine βHB, agmatine βHB, and citrulline βHB. The salts may contain the racemic DL-beta hydroxybutyrate or the single isomer R-beta hydroxybutyrate.

The term “medium chain triglycerides” (MCT) are molecules having a glycerol backbone attached to three medium chain fatty acids. Medium chain fatty acids range from 6 to 12 carbon atoms in length. Exemplary fatty acids are caprylic acid, also known as octanoic acid, comprising 8 carbon molecules (C8), and capric acid, also known as decanoic acid, comprising 10 carbon molecules (C10). Non-limiting examples and sources of the medium chain fatty acid, or an ester thereof such as a medium chain triglyceride, include coconut oil, coconut milk powder, fractionated coconut oil, palm oil, palm kernel oil, caprilic acid, isolated medium chain fatty acids, such as isolated hexanoic acid, isolated octanoic acid, isolated decanoic acid, medium chain triglycerides either purified or in natural form such as coconut oil, and ester derivatives of the medium chain fatty acids ethoxylated triglyceride, enone triglyceride derivatives, aldehyde triglyceride derivatives, monoglyceride derivatives, diglyceride derivatives, and triglyceride derivatives, and salts of the medium chain triglycerides.

A diet naturally rich in MCT can include foods such as coconut oil, palm kernel oil, and/or dairy products (e.g., milk, yogurt, cheese, and butter).

Theacrine, also known as 1,3,7,9-tetramethyluric acid, an alkaloid purine similar to caffeine, is relatively rare and only found in a few varieties of tea (kucha tea, genus Camellia), the fruit cupuacu, and other plants related to coffee and cacao (genera Coffea and Theobroma), such as Coffea liberica, Coffea dewevrei, Coffea abeokutae and Theobroma grandiflorum. There have been reports that caffeine and theacrine may induce improved mood, higher energy levels, and a reduced fatigue, increased focus, increased concentration, increased mobility, decreased appetite, and/or increased stamina. However, there have been no reports indicating any effects of either theacrine or caffeine on inducing or sustaining ketosis.

Ribose is a carbohydrate with the formula C₅H₁₀O₅. D-Ribose is an enantiomer, which occurs widely in nature. Reports have suggested that D-Ribose can be used to improve athletic performance. However, there have been no reports indicating any effects of D-Ribose on inducing or sustaining ketosis.

As used herein, the term, “ketogenic diet” is defined as a low carbohydrate diet, where the body produces ketones in the liver to be used as energy. The ketogenic diet forces the body to burn fatty acids rather than carbohydrates.

As used herein, the term “pharmaceutically acceptable salt” is defined as a salt wherein the desired biological activity of the inhibitor is maintained and which exhibits a minimum of undesired toxicological effects. Non-limiting examples of such a salt are (a) acid addition salts formed with inorganic acids (e.g., hydrochloric acid, hydrobromic acid, sulphuric acid, phosphoric acid, nitric acid, and the like), and salts formed with organic acids (such as e.g. acetic acid, oxalic acid, tartaric acid, succinic acid, malic acid, ascorbic acid, benzoic acid, tannic acid, palmitic acid, polyglutamic acid, naphthalene sulphonic acid, naphthalene disulphonic acid, polygalacturonic acid and the like); (b) base additional salts formed with metal cations such as zinc, calcium, bismuth, barium, magnesium, aluminium, copper, cobalt, nickel, cadmium, sodium, potassium and the like, or with a cation formed from ammonia, N,N-dibenzylethylenediamine, D-glucosamine, tetraethylammonium or ethylenediamine; or (c) combinations of (a) and (b); e.g. a zinc tannate or the like.

Pharmaceutically acceptable salts include salts of compounds of the invention that are safe and effective for use in mammals and that possess a desired therapeutic activity. Pharmaceutically acceptable salts include salts of acidic or basic groups present in compounds of the invention. Pharmaceutically acceptable acid addition salts include, but are not limited to, hydrochloride, hydrobromide, hydroiodide, nitrate, sulfate, bisulfate, phosphate, acid phosphate, isonicotinate, acetate, lactate, salicylate, citrate, tartrate, pantothenate, bitartrate, ascorbate, succinate, maleate, gentisinate, fumarate, gluconate, glucaronate, saccharate, formate, benzoate, glutamate, methanesulfonate, ethanesulfonate, benzensulfonate, p-toluenesulfonate and pamoate (i.e., 1,1′-methylene-bis-(2-hydroxy-3-naphthoate)) salts. Certain compounds of the invention may form pharmaceutically acceptable salts with various amino acids. Suitable base salts include, but are not limited to, aluminium, calcium, lithium, magnesium, potassium, sodium, zinc, and diethanolamine salts. For additional information on some pharmaceutically acceptable salts that can be used to practice the invention please reviews such as Berge, et al., 66 J. PHARM. SCI. 1-19 (1977), Haynes, et al, J. Pharma. Sci., Vol. 94, No. 10, October 2005, pgs. 2111-2120 and See, e.g., P. Stahl, et al., HANDBOOK OF PHARMACEUTICAL SALTS: PROPERTIES, SELECTION AND USE, (VCHA/Wiley-VCH, 2002); S. M. Berge, et al., “Pharmaceutical Salts,” Journal of Pharmaceutical Sciences, Vol. 66, No. 1, January 1977.

Dietary supplements and/or pharmaceutical formulation: The compounds of the invention and their salts may be formulated as dietary supplements or as pharmaceutical compositions for administration. Such compositions and processes for making the same are known in the art for both humans and non-human mammals. See, e.g., REMINGTON: THE SCIENCE AND PRACTICE OF PHARMACY, (A. Gennaro, et al., eds., 19^{th} ed., Mack Publishing Co., 1995). Formulations can be administered through various means, including oral administration, parenteral administration such as injection (intramuscular, subcutaneous, intravenous, intraperitoneal and/or the like); transdermal administration such as dipping, spray, bathing, washing, pouring-on and spotting-on, and dusting, or the like. Additional active ingredients may be included in the formulation comprising compounds of the invention or a salt or salts thereof.

The formulations of the present invention include those suitable for oral, parenteral (including subcutaneous, intradermal, intramuscular and intravenous) and rectal administration. The formulations may be presented in unit dosage form and may be prepared by any of the methods well known in the art of pharmacy. All methods include the step of bringing into association the active ingredient, i.e., the compound or salt of the present invention, with the carrier. In general, the formulations are prepared by uniformly and intimately bringing into association the active ingredient with a liquid carrier or, a finely divided solid carrier or both, and then, if necessary, forming the associated mixture into the desired formulation.

The formulations of the present invention suitable for oral administration may be presented as discrete units, such as a capsule, cachet, tablet, or lozenge, each containing a predetermined amount of the active ingredient; as a powder or granules; as a solution or a suspension in an aqueous liquid or non-aqueous liquid such as a syrup, elixir or a draught, or as an oil-in-water liquid emulsion or a water-in-oil liquid emulsion. The formulation may also be a bolus, electuary or paste. Some of the compositions are formulated for use in low liquid volumes such as 2 ounces or less than 2 ounces by volume.

The formulations of the present invention include formulations suitable for parenteral administration and include aqueous and non-aqueous sterile injection solutions, and may also include an antioxidant, buffer, a bacteriostat and a solution which renders the composition isotonic with the blood of the recipient, and aqueous and non-aqueous sterile suspensions which may contain, for example, a suspending agent and a thickening agent. The formulations may be presented in a single unit-dose or multi-dose containers, and may be stored in a lyophilized condition requiring the addition of a sterile liquid carrier prior to use.

Acceptable carriers include, pharmaceutically acceptable carriers or carriers categorized as Generally Regarded as Safe (GRAS). Unless stated or implied otherwise, the term carrier is used herein to describe any ingredient other than the active component(s) that maybe included in a formulation. The choice of carrier will to a large extent depend on factors such as the particular mode of administration, the effect of the carrier on solubility and stability, and the nature of the dosage form.

A tablet may be made by compressing or moulding the active ingredient with the pharmaceutically acceptable carrier. Compressed tablets may be prepared by compressing in a suitable machine the active ingredient in a free-flowing form, such as a powder or granules, in admixture with, for example, a binding agent, an inert diluent, a lubricating agent, a disintegrating and/or a surface active agent. Moulded tablets may be prepared by moulding in a suitable machine a mixture of the powdered active ingredient moistened with an inert liquid diluent. The tablets may optionally be coated or scored and may be formulated so as to provide slow or controlled release of the active ingredient.

Some embodiments include one or more flavorants and/or sweeteners. Characteristically, there are a sufficient number of flavorants and/or sweeteners so that unpalatable tasting components will be masked. Such masking is particularly necessary for caffeine. In certain embodiments, the flavorants are present in an amount from about 0.01% to about 0.5% by weight. Consistent with these embodiments, the flavorants are present in an amount from about 0.05% to about 0.2% by weight. Stevia is an example of a sweetener that may be used in the present embodiment. Other embodiments, Stevia is present in an amount from about 0.1 to about 0.15% by weight. Ethylene diamine tetraacetic acid (“EDTA”) may also be included in the present embodiment to improve flavor. The composition can also include one or more fruit flavorants. Such fruit flavorants include, but are not limited to lemon flavors, lime flavors, orange flavors, berry flavors, high fructose corn syrup, raspberry juice concentrates, berry juice concentrates and the like. Some embodiments include one or more preservatives. A preservative is a substance or a chemical that can be added to a composition in order to prevent or reduce decomposition, for example, by microbial growth or undesirable chemical changes. Some embodiments include at least one all-natural flavor enhancer and/or anti-microbial agent including, but is not limited to, cultured dextrose, cultrued wheat, wheat flour, cultured whey, organic wheat flour, lactic acid, silicon dioxide, canola oil, fumaric acid, acetic acid, or any combination thereof, in an amount from about 0.01% to about 5% by weight, from about 1% to about 5% by weight, from about 2% to about 4% by weight, and/or about 1%, 2%, 3%, 4%, and 5% by weight, or any combination thereof. All-natural flavor enhancers and/or anti-microbial agents are available and can be purchased, for example, from MESSONIFOODS NATURAL SOLUTIONS.

In one embodiment, the preferred route of administration of the composition is oral. The composition may be delivered as a powdered mixture, as a ready-to-drink liquid, in hard or soft gelatin caps, as hard-pressed tablets, concentrated gels, or any other dosage form known to those trained in the art. The composition is preferably delivered in the form of a ready-to-drink formula comprising a mixture of sodium and potassium βHB and MCT oil along with caffeine and theacrine. The drink may be pH adjusted with at least one acid includes, but is not limited to, citric, tartaric, phosphoric and/or malic acid, and artificial sweetener and flavoring can be added. The drink is homogenized and pasteurized.

Certain embodiments are useful for weight loss and the treatment of high blood glucose or type II diabetes and can improve the user's general health in a short period of time. In another embodiment, the composition is used to facilitate weight loss, as a brain tonic, to enhance athletic performance, to help prevent diseases related to metabolic dysfunction, mitochondrial defect, and insulin resistance, as an adjunct to a ketogenic diet, as an anti-aging supplement, and other uses associated with improved metabolic health. In some embodiments, compositions are optionally administered once per day, twice per day, or three times per day to a subject desiring to reduce (and/or sustain) appetite and/or food consumption.

A recent rise in the consciousness amongst physicians and the public on obesity and obesity related diseases, overeating, and refined carbohydrate consumption has led to many people to diets that are low to very low carbohydrates. Such low and ultra-low carbohydrate diets include Very Low Carbohydrate Diets VLCD (Ketogenic), Low Carbohydrate Diets (LCD), Paleolithic Diets (PD), Calorie Restriction (CR), Intermittent Fasting (IF) and many others.

Ketosis is a metabolic state characterized by elevated levels of ketone bodies in the blood in which the cells of the body metabolize ketone bodies produced in the liver by the breakdown on medium chain fatty acids, in contrast to the state of glycolysis in which blood glucose provides most of energy required by the cells of the body and the nervous system. Ketone bodies are alternative energy substrates for both peripheral tissues and cells of the central nervous system. Briefly, during ketosis, fat stores in the body are utilized to create water soluble ketone bodies such as beta-hydroxybutyrate (βHB) and acetoacetate (also known as acetylacetonate), the main ketone bodies used for energy. Longer-term ketosis may result from ketogenic diets, calorie restriction, therapeutic fasting and/or supplementation with ketogenic precursors.

Producing a ketogenic metabolic state requires eliminating substantially all sugars and carbohydrates from the diet. For individuals who derive pleasure from eating carbohydrates (e.g., cakes, candies, breads, etc.), and other non-ketogenic foods, the necessary modifications to their diets can pose an additional hurdle to attaining and/or sustaining nutritional ketosis. Maintaining a ketogenic diet in social settings such as dining in restaurants is a major challenge for people seeking to maintain a ketogenic state. Similarly, frequent travelers may find it difficult to find the types of foods required to maintain a ketogenic diet. Many such travelers find it necessary to carry the appropriate food with them in order to maintain a ketogenic diet in a setting where few, if any, ketogenic foods are available. Some versions of the formulations disclosed herein, especially those formulated in low liquid volume amounts, or as powders, are readily available for use in these situations and can help individuals to adhere to their dietary regimes.

### EXAMPLES

A double blind placebo controlled study is carried out. The study includes a total of 34 volunteer participants (i.e., 34 subjects). Prior to beginning the study all participants complete an online survey including demographic information, and undergo Body Composition Analysis (BCA) Participants are randomly selected and assigned to either the “Placebo” group or “Treatment” group. Eighteen participants are placed in the Treatment group and 16 participants are placed in the Placebo group.

No dietary changes were discussed or encouraged during the study and one 2 oz. portion of either “Composition A” (Table 1) or “Placebo” (Table 2) was included in daily to diets of the participants for 21 consecutive days. The participants complete follow up surveys at Day 0, Day 7, Day 14, and Day 21. The surveys include questions such as, “Amount of Food Consumed,” “Appetite,” “Fullness,” “Hunger,” and “Thoughts of Food.” Participants complete the questionnaire and score on a scale of 0-10 at indicated days after the treatment (e.g., Day 0, Day 7, Day 14, and Day 21). The participants exiting the study undergo a final BCA.

TABLE 1
Composition A

| Ingredients | Amounts (±10%) | |
|---|---|---|
| MCT Oil: 90% octanoic acid (C8), 10% decanoic | 3 | g |
| acid (C10) | | |
| Ca βHB: Calcium Beta-hydroxybutyrate | 2 | g |
| Na βHB: Sodium Beta-hydroxybutyrate | 2 | g |
| Mg βHB: Magnesium Beta-hydroxybutyrate | 1 | g |
| Malic Acid | 150 | mg |
| Caffeine | 75 | mg |
| Theacrine | 50 | mg |
| D-Ribose | 1 | g |
| Sweeneter | 0.15% | |
| Flavorant | 0.2% | |
| Preservative | 1% | |
| Masking agent | 1% | |
| Defoamer | 1% | |
| | 2 | oz. total |

TABLE 2
Composition B

| Ingredients | Amounts (±10%) | |
|---|---|---|
| MCT Oil: 90% octanoic acid (C8), 10% decanoic | 3 | g |
| acid (C10) | | |
| Ca βHB: Calcium Beta-hydroxybutyrate | 2 | g |
| Na βHB: Sodium Beta-hydroxybutyrate | 2 | g |
| Mg βHB: Magnesium Beta-hydroxybutyrate | 1 | g |
| Malic Acid | 200 | mg |
| Caffeine | 75 | mg |
| Theacrine | 50 | mg |
| D-Ribose | 1 | g |
| Preservative | 1% | |
| Sweeneter | 0.75% | |
| Bitter Blocker | 0.4% | |
| Flavorant | 0.25% | |
| Defoamer | 1% | |
| | 2 | oz. total |

TABLE 3
Composition C

| Ingredients | Amounts (±10%) |
|---|---|
| MCT Oil: 90% octanoic acid (C8), 10% decanoic acid | 0.5 g-10 g |
| (C10) | |
| Ca βHB: Calcium Beta-hydroxybutyrate | 0.5 g-5 g |
| Na βHB: Sodium Beta-hydroxybutyrate | 0.5 g-5 g |
| Mg βHB: Magnesium Beta-hydroxybutyrate | 0.5 g-5 g |
| Malic Acid | 1 mg-500 mg |
| Caffeine | 1 mg-250 mg |
| Theacrine | 1 mg-150 mg |
| D-Ribose | 0.5 g-5 g |
| Preservative | 0.1%-4% |
| Sweetener | 0.25%-1% |
| Bitter Blocker | 0.1%-0.5% |
| Flavorant | 0.1%-2.5% |
| Defoamer | 0.1%-1% |
| | 2 oz. total |

TABLE 4
Composition D

| Ingredients | Amounts (±10%) |
|---|---|
| MCT Oil: 90% octanoic acid (C8), 10% decanoic acid | 0.5 g-10 g |
| (C10) | |
| Na βHB: Sodium Beta-hydroxybutyrate | 0.1 g-10 g |
| K βHB: Potassim Beta-hydroxybutyrate | 0.1 g-10 g |
| Mg βHB: Magnesium Beta-hydroxybutyrate | 0.1 g-10 g |
| Malic Acid | 0 mg-500 mg |
| Tartaric acid | 0 g-2.0 g |
| Caffeine | 0 mg-220 mg |
| Theacrine | 0 mg-150 mg |
| D-Ribose | 0.1 g-5 g |
| L-theanin | 0 mg-300 mg |
| L-tryptophan | 0 mg-500 mg |
| Cannabidiol (CBD) | 0 mg-30 mg |
| Preservative | 0.1%-4% |
| Sweetener | 0.25%-1% |
| Bitter Blocker | 0.1%-0.5% |
| Flavorant | 0.1%-3% |
| Defoamer | 0.1%-1% |
| | 2 oz. total |

TABLE 5
Composition E

| Ingredients | Amounts (±10%) |
|---|---|
| Na βHB: Sodium Beta-hydroxybutyrate | 0.1 g-10 g |
| K βHB: Potassim Beta-hydroxybutyrate | 0.1 g-10 g |
| Mg βHB: Magnesium Beta-hydroxybutyrate | 0.1 g-10 g |
| Malic Acid | 0 mg-500 mg |
| Tartaric acid | 0 g-2.0 g |
| Caffeine | 0 mg-220 mg |
| Theacrine | 0 mg-150 mg |
| D-Ribose | 0.1 g-5 g |
| L-theanin | 0 mg-300 mg |
| L-tryptophan | 0 mg-500 mg |
| Cannabidiol (CBD) | 0 mg-30 mg |
| Preservative | 0.1%-4% |
| Sweetener | 0.25%-1% |
| Bitter Blocker | 0.1%-0.5% |
| Flavorant | 0.1%-3% |
| Defoamer | 0.1%-1% |
| | 2 oz. total |

TABLE 6
Composition F

| Ingredients | Amounts (±10%) |
|---|---|
| Na βHB: Sodium Beta-hydroxybutyrate | 2 g |
| K βHB: Potassim Beta-hydroxybutyrate | 2 g |
| Mg βHB: Magnesium Beta-hydroxybutyrate | 1 g |
| Malic Acid | 100 mg-150 mg |
| Tartaric acid | 1 g |
| Caffeine | 100 mg-150 mg |
| D-Ribose | 1 g |
| Cannabidiol (CBD) | 0 mg-30 mg |
| Preservative | 0.1%-4% |
| Sweetener | 0.25%-1% |
| Bitter Blocker | 0.1%-0.5% |
| Flavorant | 0.1%-3% |
| Defoamer | 0.1%-1% |
| | 2 oz. total |

TABLE 7
Placebo

| Ingredients | Amounts |
|---|---|
| Caffeine | 50 mg |
| Sweetener | 0.15% |
| Flavorant | 0.2% |
| | 2 oz. total |

TABLE 8
Treatment Group (Day 0)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 8 | 3 | 5 | 6 | 2 | 5 | 5 | 8 | 7 | 5 |
| 2 | 4 | 7 | 7 | 7 | 7 | 7 | 5 | 5 | 4 | 5 |
| 3 | 7 | 10 | 10 | 6 | 6 | 8 | 6 | 6 | 4 | 7 |
| 4 | 10 | 9 | 9 | 9 | 9 | 9 | 8 | 9 | 9 | 10 |
| 5 | 5 | 3 | 0 | 5 | 3 | 1 | 5 | 5 | 5 | 3 |
| 6 | 6 | 1 | 5 | 5 | 7 | 5 | 2 | 7 | 3 | 1 |
| 7 | 10 | 5 | 7 | 6 | 10 | 7 | 6 | 3 | 6 | 6 |
| 8 | 6 | 5 | 7 | 6 | 2 | 6 | 6 | 5 | 2 | 5 |
| 9 | 3 | 3 | 5 | 5 | 8 | 4 | 5 | 3 | 6 | 3 |
| 10 | 5 | 5 | 7 | 4 | 7 | 4 | 5 | 6 | 5 | 7 |
| 11 | 5 | 8 | 2 | 7 | 2 | 8 | 5 | 8 | 7 | 7 |
| 12 | 8 | 7 | 7 | 7 | 7 | 7 | 7 | 7 | 7 | 7 |
| 13 | 9 | 6 | 6 | 6 | 4 | 5 | 5 | 9 | 6 | 7 |
| 14 | 7 | 5 | 3 | 3 | 3 | 3 | 5 | 5 | 3 | 5 |
| 15 | 5 | 5 | 5 | 5 | 1 | 0 | 2 | 5 | 5 | 5 |
| 16 | 5 | 2 | 3 | 6 | 8 | 5 | 6 | 5 | 7 | 4 |
| 17 | 5 | 5 | 5 | 0 | 9 | 5 | 0 | 3 | 0 | 2 |
| 18 | 6 | 1 | 1 | 0 | 3 | 3 | 0 | 0 | 0 | 1 |
| Average | 6.333 | 5 | 5.22 | 5.1667 | 5.444 | 5.111 | 4.611 | 5.5 | 4.778 | 5 |

TABLE 9
Treatment Group (Day 7)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 8 | 5 | 5 | 5 | 5 | 5 | 6 | 3 | 5 | 6 |
| 2 | 5 | 4 | 4 | 4 | 5 | 4 | 4 | 3 | 3 | 5 |
| 3 | 5 | 5 | 6 | 7 | 4 | 6 | 4 | 5 | 5 | 6 |
| 4 | 10 | 9 | 9 | 9 | 8 | 7 | 9 | 7 | 8 | 10 |
| 5 | 4 | 5 | 0 | 5 | 2 | 4 | 5 | 5 | 5 | 4 |
| 6 | 4 | 4 | 3 | 4 | 7 | 4 | 4 | 3 | 3 | 3 |
| 7 | 6 | 6 | 7 | 5 | 2 | 5 | 5 | 5 | 2 | 5 |
| 8 | 4 | 1 | 1 | 1 | 4 | 1 | 5 | 5 | 5 | 1 |
| 9 | 4 | 0 | 2 | 3 | 4 | 5 | 3 | 5 | 3 | 5 |
| 10 | 6 | 5 | 5 | 3 | 6 | 4 | 5 | 5 | 4 | 5 |
| 11 | 3 | 7 | 0 | 5 | 0 | 2 | 5 | 5 | 5 | 3 |
| 12 | 5 | 5 | 5 | 5 | 4 | 2 | 2 | 2 | 4 | 2 |
| 13 | 5 | 5 | 3 | 8 | 3 | 5 | 5 | 9 | 7 | 6 |
| 14 | 0 | 0 | 0 | 0 | 0 | 0 | 0 | 5 | 1 | 0 |
| 15 | 5 | 5 | 5 | 5 | 0 | 0 | 3 | 5 | 5 | 3 |
| 16 | 0 | 0 | 0 | 0 | 0 | 0 | 0 | 0 | 0 | 4 |
| 17 | 2 | 0 | 0 | 0 | 5 | 0 | 0 | 3 | 0 | 1 |
| 18 | 1 | 1 | 2 | 2 | 2 | 1 | 0 | 1 | 0 | 3 |
| Average | 4.278 | 3.722 | 3.167 | 3.9444 | 3.389 | 3.056 | 3.611 | 4.222 | 3.611 | 3 |

TABLE 10
Treatment Group (Day 14)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 6 | 5 | 4 | 4 | 2 | 3 | 6 | 5 | 5 | 5 |
| 2 | 5 | 5 | 5 | 5 | 5 | 5 | 5 | 5 | 5 | 5 |
| 3 | 7 | 5 | 7 | 4 | 4 | 8 | 1 | 5 | 3 | 5 |
| 4 | 7 | 8 | 8 | 8 | 6 | 7 | 6 | 6 | 6 | 6 |
| 5 | 6 | 5 | 0 | 4 | 1 | 0 | 3 | 0 | 2 | 3 |
| 6 | 3 | 1 | 1 | 1 | 4 | 4 | 3 | 3 | 2 | 2 |
| 7 | 4 | 1 | 2 | 2 | 3 | 5 | 3 | 4 | 4 | 5 |
| 8 | 7 | 6 | 6 | 5 | 1 | 6 | 5 | 5 | 1 | 5 |
| 9 | 1 | 1 | 1 | 1 | 5 | 4 | 5 | 5 | 1 | 3 |
| 10 | 2 | 1 | 0 | 2 | 1 | 0 | 0 | 5 | 0 | 1 |
| 11 | 5 | 5 | 3 | 2 | 6 | 4 | 4 | 4 | 4 | 5 |
| 12 | 4 | 6 | 1 | 6 | 2 | 5 | 5 | 5 | 6 | 5 |
| 13 | 1 | 1 | 1 | 1 | 2 | 1 | 1 | 5 | 1 | 1 |
| 14 | 0 | 1 | 0 | 0 | 0 | 0 | 0 | 0 | 0 | 0 |
| 15 | 0 | 0 | 0 | 0 | 3 | 0 | 0 | 5 | 0 | 3 |
| 16 | 0 | 0 | 0 | 0 | 0 | 0 | 0 | 0 | 0 | 3 |
| 17 | 2 | 1 | 2 | 3 | 6 | 4 | 3 | 2 | 1 | 2 |
| 18 | 2 | 2 | 1 | 0 | 4 | 0 | 0 | 0 | 0 | 3 |
| Average | 3.444 | 3 | 2.333 | 2.6667 | 3.056 | 3.111 | 2.778 | 3.556 | 2.278 | 3.444 |

TABLE 11
Treatment Group (Day 21)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 4 | 2 | 2 | 5 | 2 | 3 | 3 | 5 | 5 | 4 |
| 2 | 5 | 5 | 5 | 5 | 5 | 5 | 5 | 5 | 5 | 5 |
| 3 | 3 | 3 | 3 | 5 | 3 | 3 | 3 | 4 | 1 | 7 |
| 4 | 9 | 7 | 6 | 7 | 7 | 7 | 7 | 6 | 6 | 8 |
| 5 | 5 | 2 | 0 | 5 | 2 | 1 | 2 | 5 | 1 | 1 |
| 6 | 2 | 1 | 1 | 1 | 4 | 3 | 1 | 2 | 4 | 3 |
| 7 | 1 | 0 | 1 | 0 | 5 | 0 | 1 | 5 | 0 | 1 |
| 8 | 6 | 6 | 7 | 5 | 2 | 5 | 6 | 4 | 6 | 4 |
| 9 | 5 | 0 | 2 | 3 | 7 | 2 | 3 | 3 | 3 | 4 |
| 10 | 0 | 0 | 0 | 0 | 0 | 0 | 0 | 0 | 0 | 0 |
| 11 | N/A | N/A | N/A | N/A | N/A | N/A | N/A | N/A | N/A | N/A |
| 12 | 4 | 7 | 3 | 5 | 1 | 2 | 5 | 5 | 7 | 5 |
| 13 | 1 | 1 | 1 | 1 | 1 | 1 | 1 | 1 | 1 | 1 |
| 14 | 0 | 0 | 0 | 0 | 0 | 0 | 0 | 0 | 0 | 5 |
| 15 | 0 | 0 | 0 | 0 | 0 | 0 | 3 | 6 | 6 | 3 |
| 16 | 3 | 0 | 0 | 0 | 0 | 0 | 2 | 4 | 2 | 2 |
| 17 | 5 | 3 | 3 | 3 | 3 | 2 | 4 | 3 | 2 | 1 |
| 18 | 0 | 0 | 0 | 0 | 7 | 0 | 0 | 0 | 0 | 2 |
| Average | 3.118 | 2.176 | 2 | 2.6471 | 2.882 | 2 | 2.706 | 3.412 | 2.882 | 3.294 |

TABLE 12
Placebo Group (Day 0)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 5 | 7 | 5 | 7 | 7 | 5 | 5 | 4 | 6 | 6 |
| 2 | N/A | N/A | N/A | N/A | N/A | N/A | N/A | N/A | N/A | N/A |
| 3 | 5 | 2 | 2 | 2 | 0 | 2 | 5 | 3 | 3 | 3 |
| 4 | 3 | 2 | 5 | 5 | 5 | 5 | 0 | 3 | 5 | 1 |
| 5 | 7 | 10 | 4 | 0 | 10 | 5 | 3 | 2 | 4 | 3 |
| 6 | 5 | 0 | 0 | 0 | 0 | 2 | 5 | 8 | 8 | 4 |
| 7 | 6 | 7 | 0 | 4 | 7 | 5 | 5 | 6 | 5 | 5 |
| 8 | 3 | 2 | 2 | 5 | 6 | 5 | 5 | 5 | 3 | 0 |
| 9 | 5 | 5 | 0 | 5 | 5 | 5 | 5 | 5 | 5 | 3 |
| 10 | 6 | 7 | 4 | 5 | 4 | 5 | 5 | 1 | 3 | 5 |
| 11 | 5 | 4 | 6 | 6 | 5 | 5 | 5 | 4 | 6 | 5 |
| 12 | 10 | 10 | 10 | 9 | 9 | 8 | 10 | 3 | 10 | 7 |
| 13 | 5 | 5 | 5 | 5 | 5 | 5 | 5 | 5 | 5 | 5 |
| 14 | 4 | 3 | 4 | 4 | 3 | 2 | 1 | 5 | 2 | 1 |
| 15 | 1 | 1 | 1 | 1 | 1 | 1 | 1 | 8 | 0 | 1 |
| 16 | 6 | 5 | 7 | 6 | 3 | 5 | 5 | 5 | 1 | 1 |
| Average | 5.1 | 4.6 | 4.2 | 4.2 | 4.6 | 4.3 | 4.3 | 4.5 | 4.4 | 3.3 |

TABLE 13
Placebo Group (Day 7)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 6 | 6 | 7 | 7 | 8 | 4 | 5 | 5 | 6 | 5 |
| 2 | 5 | 1 | 1 | 3 | 8 | 8 | 5 | 6 | 7 | 5 |
| 3 | 5 | 2 | 2 | 2 | 2 | 2 | 4 | 4 | 3 | 3 |
| 4 | 2 | 0 | 2 | 0 | 0 | 1 | 4 | 1 | 1 | 2 |
| 5 | 5 | 8 | 7 | 4 | 0 | 1 | 3 | 2 | 0 | 4 |
| 6 | 0 | 0 | 0 | 0 | 0 | 0 | 0 | 0 | 0 | 0 |
| 7 | 5 | 5 | 0 | 2 | 4 | 5 | 5 | 4 | 5 | 4 |
| 8 | 4 | 1 | 1 | 1 | 4 | 1 | 5 | 5 | 5 | 1 |
| 9 | 5 | 5 | 0 | 1 | 5 | 5 | 5 | 5 | 5 | 3 |
| 10 | 6 | 6 | 0 | 0 | 3 | 0 | 6 | 6 | 2 | 3 |
| 11 | 6 | 3 | 3 | 3 | 3 | 5 | 5 | 7 | 6 | 5 |
| 12 | 3 | 2 | 2 | 4 | 1 | 3 | 2 | 2 | 4 | 6 |
| 13 | 0 | 0 | 0 | 0 | 0 | 0 | 0 | 0 | 0 | 2 |
| 14 | 3 | 1 | 1 | 1 | 2 | 0 | 0 | 0 | 0 | 1 |
| 15 | 2 | 0 | 1 | 0 | 1 | 1 | 1 | 5 | 1 | 0 |
| 16 | 2 | 1 | 2 | 2 | 2 | 4 | 2 | 1 | 1 | 2 |
| Average | 3.6875 | 2.563 | 1.813 | 1.875 | 2.688 | 2.5 | 3.25 | 3.313 | 2.875 | 2.875 |

TABLE 14
Placebo Group (Day 14)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 6 | 5 | 4 | 4 | 2 | 3 | 6 | 5 | 5 | 5 |
| 2 | 5 | 5 | 5 | 5 | 5 | 5 | 5 | 5 | 5 | 5 |
| 3 | 7 | 5 | 7 | 4 | 4 | 8 | 1 | 5 | 3 | 5 |
| 4 | 7 | 8 | 8 | 8 | 6 | 7 | 6 | 6 | 6 | 6 |
| 5 | 6 | 5 | 0 | 4 | 1 | 0 | 3 | 0 | 2 | 3 |
| 6 | 3 | 1 | 1 | 1 | 4 | 4 | 3 | 3 | 2 | 2 |
| 7 | 4 | 1 | 2 | 2 | 3 | 5 | 3 | 4 | 4 | 5 |
| 8 | 7 | 6 | 6 | 5 | 1 | 6 | 5 | 5 | 1 | 5 |
| 9 | 1 | 1 | 1 | 1 | 5 | 4 | 5 | 5 | 1 | 3 |
| 10 | 2 | 1 | 0 | 2 | 1 | 0 | 0 | 5 | 0 | 1 |
| 11 | 5 | 5 | 3 | 2 | 6 | 4 | 4 | 4 | 4 | 5 |
| 12 | 4 | 6 | 1 | 6 | 2 | 5 | 5 | 5 | 6 | 5 |
| 13 | 1 | 1 | 1 | 1 | 2 | 1 | 1 | 5 | 1 | 1 |
| 14 | 0 | 1 | 0 | 0 | 0 | 0 | 0 | 0 | 0 | 0 |
| 15 | 0 | 0 | 0 | 0 | 3 | 0 | 0 | 5 | 0 | 3 |
| 16 | 0 | 0 | 0 | 0 | 0 | 0 | 0 | 0 | 0 | 3 |
| Average | 3.875 | 3 | 2.563 | 2.875 | 3.063 | 3.5 | 3.5625 | 4 | 3.125 | 2.9375 |

TABLE 15
Placebo Group (Day 21)

| | Amount of | Type of | Type of | Type of | Type of | Type of | | | | |
|---|---|---|---|---|---|---|---|---|---|---|
| | Food | Food | Food | Food | Food | Food | | | | Think |
| | Consumed | Consumed: | Consumed: | Consumed: | Consumed: | Consumed: | | | | of |
| Subject | (Scale 0-10) | Fatty | Salty | Savory | Sweet | Snack | Appetite | Fullness | Hunger | Food |
| 1 | 6 | 5 | 6 | 6 | 7 | 5 | 5 | 6 | 4 | 5 |
| 2 | 5 | 2 | 2 | 3 | 7 | 6 | 6 | 5 | 5 | 5 |
| 3 | 3 | 2 | 2 | 2 | 1 | 2 | 1 | 1 | 0 | 1 |
| 4 | 1 | 0 | 3 | 2 | 3 | 5 | 2 | 1 | 3 | 4 |
| 5 | 1 | 5 | 5 | 1 | 0 | 0 | 0 | 0 | 0 | 0 |
| 6 | 1 | 0 | 0 | 0 | 0 | 0 | 0 | 0 | 0 | 1 |
| 7 | 5 | 5 | 0 | 2 | 5 | 5 | 5 | 5 | 5 | 4 |
| 8 | 2 | 0 | 2 | 2 | 2 | 3 | 5 | 5 | 0 | 0 |
| 9 | 3 | 1 | 1 | 1 | 3 | 1 | 3 | 5 | 5 | 3 |
| 10 | 5 | 0 | 0 | 0 | 0 | 5 | 4 | 7 | 7 | 3 |
| 11 | 8 | 7 | 7 | 7 | 7 | 7 | 8 | 9 | 8 | 6 |
| 12 | 7 | 7 | 3 | 7 | 3 | 5 | 4 | 5 | 5 | 5 |
| 13 | 5 | 5 | 5 | 5 | 5 | 5 | 5 | 5 | 5 | 5 |
| 14 | 2 | 2 | 2 | 1 | 5 | 2 | 1 | 5 | 0 | 1 |
| 15 | 2 | 0 | 1 | 1 | 3 | 0 | 2 | 5 | 4 | 2 |
| 16 | 1 | 0 | 1 | 1 | 0 | 3 | 1 | 5 | 2 | 3 |
| Average | 3.563 | 2.563 | 2.5 | 2.5625 | 3.188 | 3.375 | 3.25 | 4.313 | 3.313 | 3 |

TABLE 16
Treatment Group (Summary in Part)

| | Amount of Food | Appetite | Fullness | Hunger | Think of Food |
|---|---|---|---|---|---|
| | Consumed (Average) | (Average) | (Average) | (Average) | (Average) |
| Day 0 | 6.333 | 4.611 | 5.5 | 4.778 | 5 |
| Day 7 | 4.278 | 3.611 | 4.222 | 3.611 | 3 |
| Day 14 | 3.444 | 2.778 | 3.556 | 2.278 | 3.444 |
| Day 21 | 3.118 | 2.706 | 3.412 | 2.882 | 3.294 |
| % Reduction | | | | | |
| Day 0 | 100.00% | 100.00% | 100.00% | 100.00% | 100.00% |
| Day 7 | 67.55% | 78.31% | 76.76% | 75.58% | 60.00% |
| Day 14 | 54.38% | 60.25% | 64.65% | 47.68% | 68.88% |
| Day 21 | 49.23% | 58.69% | 62.04% | 60.32% | 65.88% |

TABLE 17
Placebo Group (Summary in Part)

| | Amount of Food | Appetite | Fullness | Hunger | Think of Food |
|---|---|---|---|---|---|
| | Consumed (Average) | (Average) | (Average) | (Average) | (Average) |
| Day 0 | 5.1 | 4.3 | 4.5 | 4.4 | 3.3 |
| Day 7 | 3.688 | 3.25 | 3.313 | 2.875 | 2.875 |
| Day 14 | 3.875 | 3.563 | 4 | 3.125 | 2.938 |
| Day 21 | 3.563 | 3.25 | 4.313 | 3.313 | 3 |
| % Reduction | | | | | |
| Day 0 | 100.00% | 100.00% | 100.00% | 100.00% | 100.00% |
| Day 7 | 72.31% | 75.58% | 73.62% | 65.34% | 87.12% |
| Day 14 | 75.98% | 82.86% | 88.89% | 71.02% | 89.03% |
| Day 21 | 69.86% | 75.58% | 95.84% | 75.30% | 90.91% |

TABLE 18
Treatment Group (Day 0)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 5 | 3 | 4 | 1 | 2 | 4 | 2 | 2 |
| 2 | 5 | 5 | 3 | 3 | N/A | 6 | 2 | 7 |
| 3 | 4 | 6 | 5 | 2 | 9 | 3 | 8 | 9 |
| 4 | 7 | 8 | 7 | 6 | 7 | 7 | 6 | 6 |
| 5 | 5 | 2 | 3 | 1 | 7 | 3 | 5 | 5 |
| 6 | 2 | 1 | 8 | 0 | 10 | 1 | 10 | 9 |
| 7 | 5 | 2 | 8 | 0 | 7 | 2 | 3 | 7 |
| 8 | 5 | 2 | 5 | 1 | 0 | 5 | 2 | 3 |
| 9 | 2 | 0 | 7 | 0 | 3 | 5 | 5 | 1 |
| 10 | 5 | 5 | 5 | 2 | 1 | 0 | 7 | 7 |
| 11 | 3 | 2 | 2 | 0 | 2 | 3 | 5 | 1 |
| 12 | 1 | 0 | 2 | 0 | 7 | 4 | 6 | 1 |
| 13 | 5 | 3 | 5 | 0 | 1 | 5 | 3 | 2 |
| 14 | 0 | 0 | 7 | 0 | 0 | 0 | 5 | 2 |
| 15 | 5 | 5 | 6 | 1 | 5 | 2 | 5 | 3 |
| 16 | 1 | 2 | 4 | 1 | 7 | 5 | 6 | 3 |
| 17 | 1 | 0 | 2 | 0 | 8 | 3 | N/A | 3 |
| 18 | 5 | 2 | 1 | 1 | 7 | 2 | 8 | 1 |
| Average | 3.667 | 2.667 | 4.667 | 1.056 | 4.882 | 3.333 | 5.176 | 4 |

TABLE 19
Treatment Group (Day 7)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 5 | 1 | 3 | 0 | 2 | 5 | 3 | 3 |
| 2 | 4 | 4 | 5 | 4 | 7 | 3 | 5 | 5 |
| 3 | 4 | 8 | 2 | 7 | 3 | 5 | 6 | 6 |
| 4 | 7 | 8 | 3 | 5 | 7 | 6 | 6 | 5 |
| 5 | 1 | 0 | 3 | 0 | 3 | 3 | 5 | 5 |
| 6 | 1 | 1 | 1 | 0 | 1 | 1 | 1 | 1 |
| 7 | 4 | 1 | 5 | 2 | 8 | 1 | 5 | 7 |
| 8 | 0 | 0 | 0 | 0 | 6 | 0 | 3 | 3 |
| 9 | 1 | 0 | 0 | 0 | 7 | 2 | 7 | 1 |
| 10 | 5 | 5 | 5 | 6 | 5 | 4 | 5 | 4 |
| 11 | 3 | 3 | 3 | 3 | 6 | 5 | 5 | 2 |
| 12 | 2 | 3 | 7 | 0 | 8 | 2 | 7 | 7 |
| 13 | 5 | 5 | 6 | 0 | 2 | 5 | 5 | 2 |
| 14 | 0 | 0 | 5 | 0 | 7 | 2 | 6 | 3 |
| 15 | 4 | 3 | 5 | 1 | 6 | 4 | 5 | 6 |
| 16 | 8 | 2 | 6 | 0 | 8 | 6 | 3 | 3 |
| 17 | 0 | 1 | 0 | 0 | 7 | 1 | 5 | 2 |
| 18 | 2 | 1 | 2 | 1 | 5 | 1 | 8 | 7 |
| Average | 3.111 | 2.556 | 3.389 | 1.611 | 5.444 | 3.111 | 5 | 4 |

TABLE 20
Treatment Group (Day 14)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 3 | 1 | 2 | 1 | 3 | 3 | 2 | 1 |
| 2 | 5 | 5 | 5 | 5 | 5 | 5 | 5 | 5 |
| 3 | 5 | 8 | 6 | 1 | 6 | 4 | 6 | 6 |
| 4 | 7 | 8 | 7 | 4 | 7 | 7 | 6 | 7 |
| 5 | 1 | 0 | 2 | 0 | 1 | 5 | 1 | 3 |
| 6 | 2 | 2 | 2 | 1 | 1 | 1 | 1 | 2 |
| 7 | 1 | 1 | 7 | 1 | 8 | 0 | 5 | 8 |
| 8 | 5 | 2 | 2 | 1 | 7 | 5 | 6 | 6 |
| 9 | 0 | 0 | 0 | 0 | 0 | 0 | 4 | 2 |
| 10 | 1 | 0 | 2 | 4 | 1 | 1 | 3 | 4 |
| 11 | 7 | 8 | 4 | 9 | 5 | 8 | 3 | 3 |
| 12 | 4 | 3 | 6 | 5 | 3 | 6 | 5 | 4 |
| 13 | 1 | 1 | 1 | 0 | 1 | 1 | 5 | 1 |
| 14 | 5 | 3 | 4 | 0 | 3 | 5 | 5 | 3 |
| 15 | 0 | 0 | 3 | 0 | 2 | 0 | 5 | 0 |
| 16 | 1 | 1 | 5 | 2 | 6 | 4 | 5 | 2 |
| 17 | 3 | 1 | 3 | 2 | 3 | 4 | 7 | 7 |
| 18 | 0 | 0 | 0 | 0 | 3 | 0 | 5 | 5 |
| Average | 2.833 | 2.444 | 3.389 | 2 | 3.611 | 3.278 | 4.389 | 3.833 |

TABLE 21
Treatment Group (Day 21)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 1 | 1 | 1 | 1 | 1 | 1 | 2 | 2 |
| 2 | 5 | 5 | 5 | 4 | 5 | 6 | 5 | 5 |
| 3 | 2 | 3 | 3 | 0 | 2 | 0 | 3 | 3 |
| 4 | 6 | 6 | 7 | 4 | 7 | 7 | 6 | 6 |
| 5 | 0 | 0 | 0 | 0 | 0 | 2 | 1 | 3 |
| 6 | 1 | 0 | 3 | 0 | 2 | 2 | 2 | 2 |
| 7 | 1 | 1 | 7 | 3 | 6 | 1 | 5 | 6 |
| 8 | 5 | 3 | 3 | 1 | 3 | 5 | 3 | 3 |
| 9 | 0 | 0 | 1 | 0 | 1 | 1 | 1 | 1 |
| 10 | 2 | 0 | 3 | 3 | 2 | 2 | 7 | 5 |
| 11 | | | | | | | | |
| 12 | 5 | 4 | 4 | 3 | 6 | 5 | 7 | 2 |
| 13 | 0 | 0 | 1 | 1 | 1 | 5 | 1 | 1 |
| 14 | 5 | 4 | 5 | 0 | 4 | 3 | 6 | 3 |
| 15 | 0 | 2 | 2 | 1 | 2 | 0 | 3 | 2 |
| 16 | 2 | 3 | 3 | 1 | 6 | 3 | 5 | 7 |
| 17 | 4 | 1 | 2 | 1 | 3 | 3 | 3 | 4 |
| 18 | 0 | 0 | 0 | 0 | 0 | 0 | 5 | 2 |
| Average | 2.294118 | 1.9412 | 2.941176 | 1.35294118 | 3 | 2.7058824 | 3.8235 | 3.352941 |

TABLE 22
Placebo Group (Day 0)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 4 | 5 | 5 | 2 | 8 | 4 | 6 | 6 |
| 2 | N/A | N/A | N/A | N/A | N/A | N/A | N/A | N/A |
| 3 | 1 | 2 | 2 | 0 | 6 | 2 | 5 | 4 |
| 4 | 3 | 5 | 1 | 0 | 6 | 1 | 9 | 4 |
| 5 | 6 | 7 | 4 | 3 | 2 | 5 | 5 | 1 |
| 6 | 0 | 0 | 2 | 0 | 0 | 3 | 6 | 0 |
| 7 | 5 | 3 | 7 | 0 | 7 | 5 | 7 | 3 |
| 8 | 2 | 0 | 2 | 0 | 0 | 1 | 5 | 0 |
| 9 | 5 | 2 | 3 | 1 | 3 | 3 | 5 | 0 |
| 10 | 1 | 0 | 1 | 0 | 1 | 0 | 0 | 0 |
| 11 | 1 | 3 | 2 | 3 | 1 | 2 | 5 | 4 |
| 12 | 5 | 7 | 4 | 0 | 7 | 3 | 6 | 9 |
| 13 | 5 | 5 | 5 | 5 | 5 | 5 | 5 | 2 |
| 14 | 8 | 9 | 7 | 7 | 7 | 2 | 8 | 4 |
| 15 | 8 | 9 | 0 | 1 | 5 | 7 | 7 | 7 |
| 16 | 3 | 1 | 2 | 0 | 2 | 5 | 2 | 4 |
| Average | 3.8 | 3.8 | 3.1 | 1.5 | 4 | 3.2 | 5.4 | 3.2 |

TABLE 23
Placebo Group (Day 7)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 4 | 4 | 6 | 2 | 7 | 3 | 5 | 6 |
| 2 | 4 | 5 | 4 | 0 | 8 | 6 | 5 | 4 |
| 3 | 1 | 1 | 1 | 0 | 3 | 1 | 6 | 6 |
| 4 | 3 | 1 | 1 | 0 | 1 | 1 | 3 | 2 |
| 5 | 1 | 2 | 8 | 0 | 10 | 1 | 9 | 1 |
| 6 | 1 | 0 | 2 | 0 | 0 | 0 | 3 | 2 |
| 7 | 2 | 5 | 5 | 0 | 7 | 4 | 7 | 1 |
| 8 | 0 | 0 | 0 | 0 | 0 | 0 | 5 | 0 |
| 9 | 3 | 2 | 3 | 1 | 3 | 3 | 5 | 3 |
| 10 | 0 | 0 | 0 | 0 | 0 | 0 | 0 | 0 |
| 11 | 4 | 1 | 1 | 0 | 9 | 0 | 8 | 1 |
| 12 | 5 | 5 | 5 | 4 | 3 | 5 | 5 | 0 |
| 13 | 2 | 5 | 4 | 4 | 4 | 4 | 4 | 4 |
| 14 | 3 | 2 | 4 | 3 | 3 | 1 | 5 | 4 |
| 15 | 3 | 5 | 5 | 1 | 5 | 3 | 5 | 3 |
| 16 | 2 | 2 | 2 | 0 | 2 | 1 | 1 | 1 |
| Average | 2.375 | 2.5 | 3.1875 | 0.9375 | 4.0625 | 2.0625 | 4.75 | 2.375 |

TABLE 24
Placebo Group (Day 14)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 4 | 4 | 6 | 3 | 7 | 4 | 5 | 5 |
| 2 | 6 | 4 | 4 | 1 | 8 | 5 | 3 | 4 |
| 3 | 2 | 2 | 3 | 1 | 3 | 1 | 5 | 5 |
| 4 | 0 | 2 | 1 | 0 | 2 | 0 | 2 | 4 |
| 5 | 1 | 4 | 1 | 4 | 1 | 1 | 0 | 3 |
| 6 | 0 | 0 | 0 | 0 | 0 | 0 | 5 | 0 |
| 7 | 2 | 2 | 7 | 0 | 7 | 2 | 7 | 2 |
| 8 | 0 | 0 | 0 | 0 | 0 | 0 | 5 | 0 |
| 9 | 2 | 2 | 3 | 1 | 3 | 2 | 5 | 1 |
| 10 | 0 | 0 | 0 | 0 | 0 | 0 | 0 | 0 |
| 11 | 2 | 4 | 1 | 0 | 2 | 0 | 5 | 1 |
| 12 | 5 | 4 | 5 | 3 | 7 | 5 | 5 | 0 |
| 13 | 3 | 3 | 5 | 3 | 3 | 5 | 4 | 3 |
| 14 | 5 | 8 | 1 | 5 | 5 | 2 | 6 | 6 |
| 15 | 1 | 1 | 2 | 0 | 1 | 4 | 5 | 5 |
| 16 | 0 | 0 | 1 | 0 | 1 | 1 | 1 | 1 |
| Average | 2.0625 | 2.5 | 2.5 | 1.3125 | 3.125 | 2 | 3.9375 | 2.5 |

TABLE 25
Placebo Group (Day 21)

| | Agitation | Anxiety | Calmness | Depression | Happiness | Irritability | Energy | New Info |
|---|---|---|---|---|---|---|---|---|
| Subject | (Scale 0-10) | (Scale 0-10) | (Scale 0-10) | (Scale 0-10) | (Scale 0-10) | (Scale 0-10) | (Scale 0-10) | (Scale 0-10) |
| 1 | 4 | 4 | 7 | 1 | 7 | 4 | 5 | 5 |
| 2 | 5 | 2 | 5 | 2 | 2 | 6 | 3 | 3 |
| 3 | 1 | 1 | 1 | 0 | 4 | 1 | 6 | 7 |
| 4 | 2 | 2 | 7 | 1 | 8 | 0 | 5 | 5 |
| 5 | 5 | 5 | 4 | 1 | 1 | 1 | 5 | 4 |
| 6 | 0 | 0 | 0 | 0 | 0 | 0 | 3 | 0 |
| 7 | 2 | 0 | 7 | 0 | 7 | 2 | 5 | 0 |
| 8 | 0 | 0 | 0 | 0 | 0 | 0 | 5 | 0 |
| 9 | 2 | 1 | 3 | 1 | 3 | 2 | 5 | 3 |
| 10 | 0 | 0 | 0 | 0 | 0 | 0 | 0 | 0 |
| 11 | 3 | 5 | 1 | 1 | 1 | 2 | 4 | 1 |
| 12 | 5 | 5 | 5 | 1 | 7 | 5 | 5 | 0 |
| 13 | 5 | 5 | 5 | 5 | 5 | 5 | 5 | 3 |
| 14 | 8 | 7 | 3 | 4 | 8 | 5 | 5 | 6 |
| 15 | 4 | 4 | 4 | 4 | 3 | 5 | 5 | 5 |
| 16 | 1 | 3 | 1 | 0 | 1 | 1 | 2 | 1 |
| Average | 2.9375 | 2.75 | 3.3125 | 1.3125 | 3.5625 | 2.4375 | 4.25 | 2.6875 |

Tables 1-6 represent compositions, e.g., Compositions A-F, having the listed ingredients. Table 7 represents a Placebo, having caffeine as the only active ingredient. Caffeine is added to the Placebo because it is known to assist in appetite suppression and is used as a positive control.

Tables 8-15 represent scores in a scale of 0-10 obtained from each subject participated in the study. In each group, each subject was asked to fill out a follow up survey at Day 0, Day 7, Day 14, and Day 21. These surveys included questions such as “Amount of Food Consumed,” “Type of Food Consumed,” “Appetite,” “Fullness,” “Hunger,” and “Think of Food.” Each subject was asked to provide a score in a scale of 0-10 in response to all of the questions at indicated days after the treatment (e.g., Day 0, Day 7, Day 14, and Day 21).

Tables 18-25 represent scores in a scale of 0-10 obtained from each subject participated in the study. In each group, each subject was asked to fill out a follow up survey at Day 0, Day 7, Day 14, and Day 21. These surveys included questions such as “Agitation,” “Anxiety,” “Calmness,” “Depression,” “Happiness,” “Irritability,” “Energy,” and “New Info.” Each subject was asked to provide a score in a scale of 0-10 in response to all of the questions at indicated days after the treatment (e.g., Day 0, Day 7, Day 14, and Day 21). The column heading designated, “New Info,” summarizes answers to a question posed to the participants as to whether or not the participants experienced any changes either positive or negative in their ability to process new information.

Referring now to Table 16 and 17, average scores and percent reductions in each category, for example, “Amount of Food Consumed,” “Appetite,” “Fullness,” “Hunger,” and “Think of Food” for each group were calculated at indicated days after the treatment (e.g., Day 0, Day 7, Day 14, and Day 21).

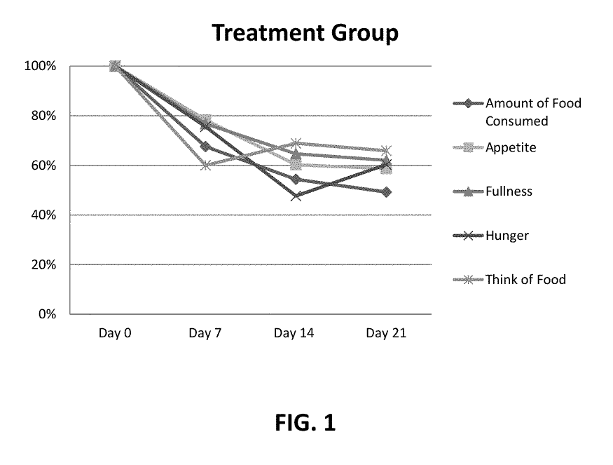

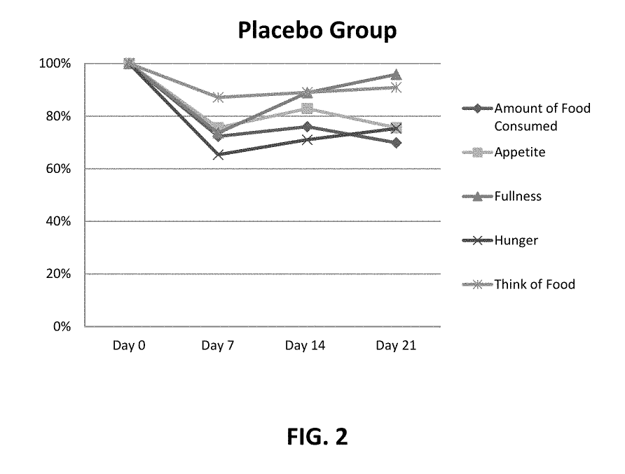

Referring now to FIGS. 1 and 2, percent reductions measured in each category and recorded in Tables 16 and 17 are presented. In the Treatment group, in average, about 51% reduction in food consumption, about 42% reduction in Appetite, about 38% reduction in Fullness, about 40% reduction in Hunger, and about 34% reduction in Think of Food categories were measured after 21 days of daily addition of Composition A. In contrast, in average, about 30% reduction in food consumption, about 24% reduction in Appetite, about 4% reduction in Fullness, 25% reduction in Hunger, and about 9% reduction in Think of Food categories were measured after 21 days of daily addition of Placebo.

All subjects in both Treatment and Placebo groups exhibited some reduction in appetite during the study. However, subjects in the Treatment group showed higher reductions in all categories tested than subjects in the Placebo group. Although the compositions described herein can assist in VLCD, LCD, PD, and IF, the compositions described herein provide significant benefit regardless of the individual's dietary plant.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety to the extent they are not inconsistent with the explicit teachings of this specification.

We claim:

1. A composition comprising:
at least one beta-hydroxybutyrate salt in an amount from about 0.1 g to about 5 g; and
at least one agent comprising D-Ribose.

2. The composition according to claim 1, further comprising:
at least one medium chain fatty acid or ester thereof in an amount from about 0.1 g to about 10 g.

3. The composition according to claim 1, further comprising at least one compound comprising malic acid, caffeine, theacrine, L-theanine, L-tryptophan, cannabidiol, or a combination thereof.

4. The composition according to claim 2, wherein the at least one medium chain fatty acid or ester thereof comprises medium chain triglycerides, coconut oil, coconut milk powder, fractionated coconut oil, palm kernel oil, isolated hexanoic acid, isolated octanoic acid, isolated decanoic acid, ethoxylated triglyceride, enone triglyceride derivatives thereof, aldehyde triglyceride derivatives thereof, monoglyceride derivatives thereof, diglyceride derivatives thereof, triglyceride derivatives thereof, or an alkyl ester thereof.

5. The composition according to claim 1, wherein the at least one beta-hydroxybutyrate salt comprises sodium beta-hydroxybutyrate, arginine beta-hydroxybutyrate, potassium beta-hydroxybutyrate, calcium beta-hydroxybutyrate, magnesium beta-hydroxybutyrate, lithium beta-hydroxybutyrate, lysine beta-hydroxybutyrate, histidine beta-hydroxybutyrate, omithine beta-hydroxybutyrate, creatine beta-hydroxybutyrate, agmatine beta-hydroxybutyrate, and/or citrulline beta-hydroxybutyrate.

6. The composition according to claim 2, wherein the at least one medium chain fatty acid or ester thereof is present in an amount from about 1 g to about 5 g, from about 1 g to about 4 g, or from about 1 g to about 3 g.

7. The composition according to claim 1, wherein the at least one beta-hydroxybutyrate salt is presented in an amount from about 0.5 g to about 4 g, from about 1 g to about 3 g, or from about 1 g to about 2 g.

8. The composition according to claim 1, wherein the composition comprises caffeine, and wherein the caffeine is presented in an amount from about 1 mg to about 250 mg, from about 1 mg to about 100 mg, from about 10 mg to about 100 mg, from about 50 mg to about 100 mg, from about 50 mg to about 80 mg, or from about 60 mg to about 80 mg.

9. The composition according to claim 1, wherein the composition comprises theacrine, and wherein the theacrine is presented in an amount from about 1 mg to about 150 mg, from about 1 mg to about 100 mg, from about 10 mg to about 100 mg, from about 20 mg to about 80 mg, from about 30 mg to about 70 mg, or from about 40 mg to about 60 mg.

10. The composition according to claim 1, wherein the composition comprises:
from about 1 g to about 3 g sodium beta-hydroxybutyrate;
from about 1 g to about 3 g potassium beta-hydroxybutyrate;
from about 0.5 g to about 2 g magnesium beta-hydroxybutyrate;
from about 100 mg to about 200 mg caffeine;
from about 50 mg to about 200 mg malic acid; and
from about 0.5 g to about 5 g D-Ribose.

11. The composition according to claim 2, wherein the composition comprises:
from about 2 g to about 4 g medium chain triglycerides having greater than 90% octanoic acid and less than 10% decanoic acid;
from about 1 g to about 3 g calcium beta-hydroxybutyrate;
from about 1 g to about 3 g sodium beta-hydroxybutyrate;
from about 1 g to about 3 g magnesium beta-hydroxybutyrate;
from about 50 mg to about 90 mg caffeine;
from about 30 mg to about 70 mg theacrine;
from about 1 mg to about 500 mg malic acid; and
from about 0.5 g to about 5 g D-Ribose.

12. Use of the composition according to claim 1 for reducing food consumption and/or body weight in a subject who is on a diet naturally rich in MCT.

13. A dietary supplement, comprising:
from about 1 mg to about 250 mg caffeine;
from about 1 mg to about 150 mg theacrine; and/or
from about 0.5 g to about 5 g D-Ribose;
wherein the dietary supplement is used in conjunction with a composition comprising at least one medium chain fatty acid and/or at least one beta-hydroxybutyrate salt.

14. The dietary supplement according to claim 13, wherein the caffeine is presented in an amount from about 5 mg to about 100 mg, from about 10 mg to about 100 mg, from about 50 mg to about 100 mg, from about 50 mg to about 80 mg, or from about 60 mg to about 80 mg.

15. The dietary supplement according to claim 13, wherein the theacrine is presented in an amount from about 5 mg to about 100 mg, from about 10 mg to about 100 mg, from about 20 mg to about 80 mg, from about 30 mg to about 70 mg, or from about 40 mg to about 60 mg.

16. The composition according to claim 1, further comprising at least one flavorant and/or at least one preservative.

17. The composition according to claim 1, wherein the composition is formulated into a liquid, and/or wherein the composition reduces food consumption in a subject.

18. A method of altering diet in a subject, comprising:
administering to a subject a therapeutically effective amount of the composition according to claim 1.

19. The method according to claim 18, wherein the therapeutically effective amount of the composition is administered to the subject once, twice, or three times per day.

20. The method according to claim 18, wherein the subject is not on a ketogenic diet and/or wherein the subject is on a diet naturally rich in MCT.
